(19) United States
(12) Patent Application Publication
(10) Pub. No.: US 2011/0110570 A1
(43) Pub. Date: May 12, 2011

(54) APPARATUS AND METHODS FOR GENERATING A PLANAR IMAGE

(76) Inventor: Avi Bar-Shalev, Kiryat Haim (IL)

(21) Appl. No.: 12/616,055

(22) Filed: Nov. 10, 2009

(51) Int. Cl. G06K 9/00

(52) U.S. Cl. 382/131

(57) ABSTRACT

An apparatus and methods for synthesizing a planar image from a three-dimensional emission dataset. The method includes acquiring a three-dimensional (3D) emission dataset of an object of interest, acquiring a three-dimensional (3D) attenuation map of the object of interest, determining a line or response that extends from an emission point in the 3D emission dataset, through the 3D attenuation map, to a pixel to be reconstructed on a planar image, integrating along the line of response to generate an attenuation corrected value for the pixel, and reconstructing the planar image using the attenuation correction value.

### BACKGROUND OF THE INVENTION

The subject matter disclosed herein relates generally to medical imaging systems, and, more particularly to an apparatus and method for generating a planar image from a three-dimensional emission data set.

Single Photon Emission Computed Tomography (SPECT) imaging systems and Positron Emission Tomography (PET) imaging systems generally acquire images showing physiologic data based on the detection of radiation from the emission of photons. Images acquired using SPECT and/or PET may be used by a physician to evaluate different conditions and diseases.

Conventional SPECT imaging systems are capable of acquiring both a three-dimensional image and a two-dimensional, or planar, image. Planar images are typically acquired by positioning a pair of gamma cameras around the patient to generate two planar images. One planar image is typically acquired from a first side of the patient and a second planar image is typically acquired from a second side of the patient. Planar images are useful in identifying bone fractures, for example, that do not require a more detailed three-dimensional image. Planar images are used by a wide range of medical personnel because planar images are relatively easy to interpret. Both hospital physicians familiar with SPECT imaging systems and other medical personnel who may be less familiar with the SPECT imaging systems benefit from planar images. However, if the physician identifies a certain feature in the planar image that requires further investigation, the physician may instruct that the patient be imaged a second time to acquire a three-dimensional image.

The three-dimensional image is typically acquired by rotating a pair of gamma cameras around the patient to generate a plurality of slices. The plurality of slices are then combined to form the three-dimensional image. Three-dimensional images enable a physician to identify a specific location and/or size of the fracture, for example.

To view the three-dimensional image, the physician typically reviews a plurality of slices to identify one or more slices that include the region of interest. For example, the physician may review many slices to identify the size and/or location of a tumor. Manually reviewing the slices to identify the specific region of interest is both time consuming and requires that the physician have certain skills in manipulating the three-dimensional images. While three-dimensional images are useful in a wide variety of medical applications, two-dimensional images are more easily understood by a wider variety of medical personnel. Moreover, conventional imaging systems acquire the planar images and the three-dimensional images in two separate scanning procedures. Thus, when a physician identifies a feature in a planar image that requires further investigation, the second scan is performed to generate the three-dimensional image. Utilizing two separate scanning procedures to acquire both a planar image and a three-dimensional image is both time consuming and increases patient discomfort. For example, U.S. Pat. No. 7,024,028 titled “Method of using frame of pixels to locate ROI in medical imaging”; to Bar Shalev, Avi; discloses a method for locating a region of interest in computerized tomographic imaging. The method describes determining a depth of frame and locating a region of interest by selecting a pixel in a two dimensional projected frame.

### BRIEF DESCRIPTION OF THE INVENTION

In one embodiment, a method for synthesizing a planar image from a three-dimensional emission dataset. The method includes acquiring a three-dimensional (3D) emission dataset of an object of interest, acquiring a three-dimensional (3D) attenuation map of the object of interest, determining a line or response that extends from an emission point in the 3D emission dataset, through the 3D attenuation map, to a pixel to be reconstructed on a planar image, integrating along the line of response to generate an attenuation corrected value for the pixel, and reconstructing the planar image using the attenuation correction value.

In another embodiment, a medical imaging system is provided. The medical imaging system includes a gamma emission camera, an anatomical topographic camera, and an image reconstruction processor. The image reconstruction processor is configured to acquire a three-dimensional (3D) emission dataset of an object of interest, acquire a three-dimensional (3D) attenuation map of the object of interest, determine a line or response that extends from an emission point in the 3D emission dataset, through the 3D attenuation map, to a pixel to be reconstructed on a planar image, integrate along the line of response to generate an attenuation corrected value for the pixel, and reconstruct the planar image using the attenuation correction value.

In another embodiment, a computer readable medium encoded with a program is provided. The computer readable medium is programmed to instruct a computer to acquire a three-dimensional (3D) emission dataset of an object of interest, acquire a three-dimensional (3D) attenuation map of the object of interest, determine a line or response that extends from an emission point in the 3D emission dataset, through the 3D attenuation map, to a pixel to be reconstructed on a planar image, integrate along the line of response to generate an attenuation corrected value for the pixel, and reconstruct the planar image using the attenuation correction value.

### BRIEF DESCRIPTION OF THE DRAWINGS

FIG. 1 is a perspective view of an exemplary nuclear medicine imaging system constructed in accordance with an embodiment of the invention described herein.

FIG. 2 is a schematic illustration of an exemplary nuclear medicine imaging system constructed in accordance with an embodiment of the invention described herein.

FIG. 3 is a flowchart illustrating an exemplary method of generating a synthetic image in accordance with an embodiment of the invention described herein.

FIG. 4 illustrates an exemplary 3D emission dataset in accordance with an embodiment of the invention described herein.

FIG. 5 illustrates a model of an exemplary patient in accordance with an embodiment of the invention described herein.

FIG. 6 illustrates of portions of an exemplary 3D emission dataset formed in accordance with an embodiment of the invention described herein.

FIG. 7 illustrates portions of the dataset shown in FIG. 6 in accordance with an embodiment of the invention described herein.

FIG. 8 illustrates a portion of the dataset shown in FIG. 6 in accordance with an embodiment of the invention described herein.

FIG. 9 illustrates a portion of the dataset shown in FIG. 6 in accordance with an embodiment of the invention described herein.

FIG. 10 illustrates a portion of the dataset shown in FIG. 6 in accordance with an embodiment of the invention described herein.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or multiple pieces of hardware) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Also as used herein, the phrase “reconstructing an image” is not intended to exclude embodiments of the present invention in which data representing an image is generated, but a viewable image is not. Therefore, as used herein the term “image” broadly refers to both viewable images and data representing a viewable image. However, many embodiments generate, or are configured to generate, at least one viewable image.

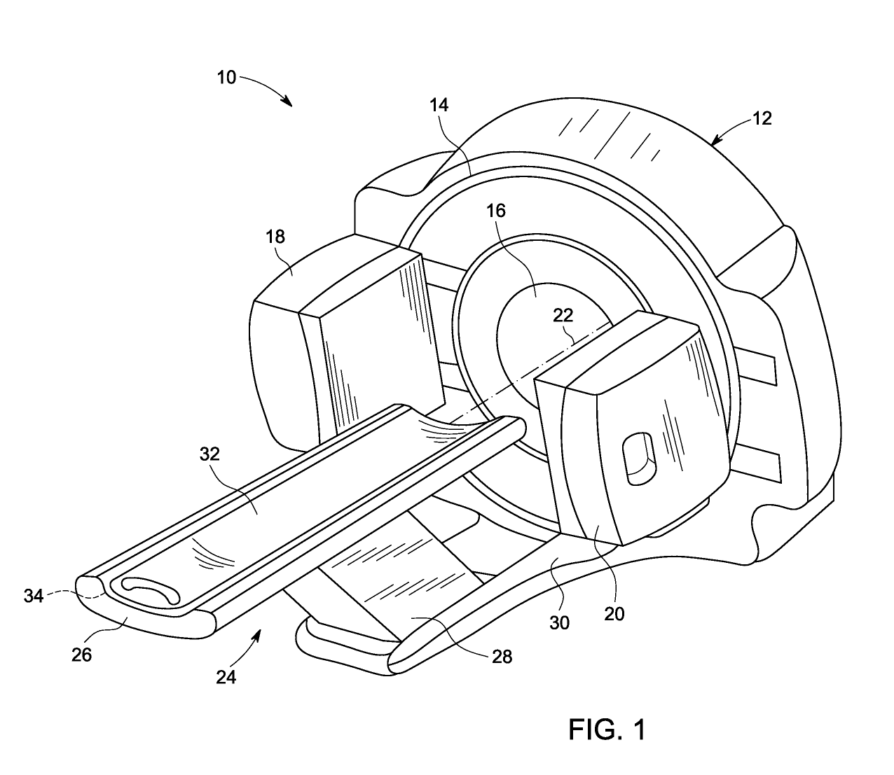

FIG. 1 is a perspective view of an exemplary medical imaging system 10 formed in accordance with various embodiments of the invention, which in this embodiment is a nuclear medicine imaging system, and more particularly, a single photon emission computed tomography (SPECT) imaging system. The system 10 includes an integrated gantry 12 that further includes a rotor 14 oriented about a gantry central bore 16. The rotor 14 is configured to support one or more nuclear medicine (NM) cameras (two gamma cameras 18 and 20 are shown), such as, but not limited to gamma cameras, SPECT detectors, multi-layer pixelated cameras (e.g., Compton camera) and/or PET detectors, stationary or moving multi-pinhole gamma camera, slit collimator gamma camera, or rotating heads solid-state gamma cameras. In various embodiments described herein, gantry 12 may be constructed without a rotor such as Philips' Skylight Nuclear Gamma Camera; Spectrum Dynamics' D-SPECT™ Cardiac Imaging System, etc. It should be noted that when the medical imaging system 10 includes a CT camera or an x-ray camera, the medical imaging system 10 also includes an x-ray tube (not shown) for emitting x-ray radiation towards the detectors. Alternatively, camera 10 may include an attenuation map acquisition unit, for example based on an external isotope source, for example as disclosed in: U.S. Pat. No. 5,210,421: Simultaneous transmission and emission converging tomography; U.S. Pat. No. 6,271,524: Gamma ray collimator; etc. Additionally or alternatively, camera 10 may be embodied as other imaging modalities capable of acquiring a 3D anatomical data of the patient, for example MRI. In various embodiments, the gamma cameras 18 and 20 are formed from pixelated detectors. The rotor 14 is further configured to rotate axially about an examination axis 22. Optionally, for example in the absence of a hardware acquired attenuation map or when it was not utilized, a synthetic attenuation map may be obtained using an emission profile and constant μ. The μ preferably chosen represents soft tissue. To obtain a synthetic attenuation map using an emission data. The reconstructed emission data is segmented with a very low count-density threshold, and optionally with energy window that admits scattered radiation. In this way, all the patient volume is identified.

A patient table 24 may include a bed 26 slidingly coupled to a bed support system 28, which may be coupled directly to a floor or may be coupled to the gantry 12 through a base 30 coupled to the gantry 12. The bed 26 may include a stretcher 32 slidingly coupled to an upper surface 34 of the bed 26. The patient table 24 is configured to facilitate ingress and egress of a patient (not shown) into an examination position that is substantially aligned with the examination axis 22. During an imaging scan, the patient table 24 may be controlled to move the bed 26 and/or the stretcher 32 axially into and out of the bore 16. The operation and control of the imaging system 10 may be performed in any suitable manner.

It should be noted that the various embodiments may be implemented in connection with imaging systems that include rotating gantries or stationary gantries.

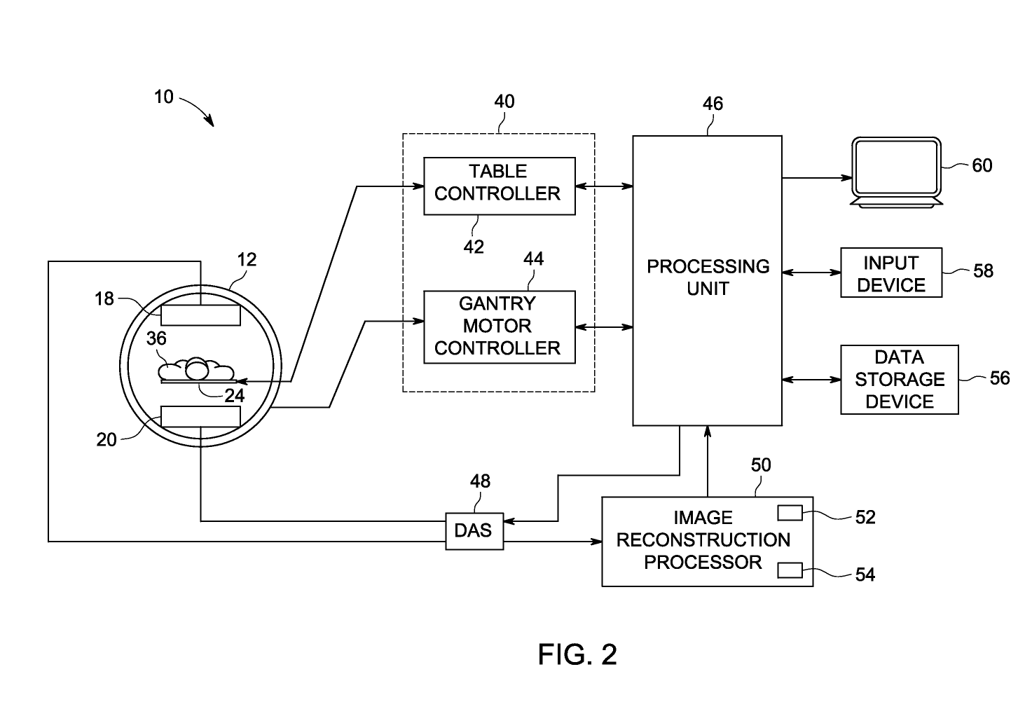

FIG. 2 is a schematic illustration of the exemplary imaging system 10 shown in FIG. 1 in accordance with various embodiments described herein. In various embodiments, two gamma cameras 18 and 20 are provided. The gamma cameras 18 and 20 are each sized to enable the system 10 to image most or all of a width of a patient's body 36. Each of the gamma cameras 18 and 20 in one embodiment are stationary, each viewing the patient 36 from one particular direction. However, the gamma cameras 18 and 20 may also rotate about the gantry 12. The gamma cameras 18 and 20 have a radiation detection face (not shown) that is directed towards, for example, the patient 36. The detection face of the gamma cameras 18 and 20 may be covered by a collimator (not shown). Different types of collimators as known in the art may be used, such as pinhole, fan-beam, cone-beam, diverging and parallel-beam type collimators.

The system 10 also includes a controller unit 40 to control the movement and positioning of the patient table 24, the gantry 12 and/or the first and second gamma cameras 18 and 20 with respect to each other to position the desired anatomy of the patient 36 within the FOVs of the gamma cameras 18 and 20 prior to acquiring an image of the anatomy of interest. The controller unit 40 may include a table controller 42 and a gantry motor controller 44 that may be automatically commanded by a processing unit 46, manually controlled by an operator, or a combination thereof. The gantry motor controller 44 may move the gamma cameras 18 and 20 with respect to the patient 36 individually, in segments or simultaneously in a fixed relationship to one another. The table controller 42 may move the patient table 24 to position the patient 36 relative to the FOV of the gamma cameras 18 and 20.

In one embodiment, the gamma cameras 18 and 20 remain stationary after being initially positioned, and imaging data is acquired and processed as discussed below. The imaging data may be combined and reconstructed into a composite image, which may comprise two-dimensional (2D) images, a three-dimensional (3D) volume or a 3D volume over time (4D).

A Data Acquisition System (DAS) 48 receives analog and/or digital electrical signal data produced by the gamma cameras 18 and 20 and decodes the data for subsequent processing. An image reconstruction processor 50 receives the data from the DAS 48 and reconstructs an image of the patient 36. In the exemplary embodiment, the image reconstruction processor 50 reconstructs a first planar image 52 that is representative of the data received from the gamma camera 18. The image reconstruction processor 50 also reconstructs a second planar image 54 that is representative of the data received from the gamma camera 20. A data storage device 56 may be provided to store data from the DAS 48 or reconstructed image data. An input device 58 also may be provided to receive user inputs and a display 60 may be provided to display reconstructed images.

In operation, the patient 36 is injected with a radiopharmaceutical. A radiopharmaceutical is a substance that emits photons at one or more energy levels. While moving through the patient's blood stream, the radiopharmaceutical becomes concentrated in an organ to be imaged. By measuring the intensity of the photons emitted from the organ, organ characteristics, including irregularities, can be identified. The image reconstruction processor 50 receives the signals and digitally stores corresponding information as an M by N array of elements called pixels. The values of M and N may be, for example 64 or 128 pixels across the two dimensions of the image. Together the array of pixel information is used by the image reconstruction processor 50 to form emission images, namely planar images 52 and 54, that correspond to the specific position of the gamma cameras 18 and 20, respectively.

However, because different materials are characterized by different attenuation coefficients, photons are attenuated to different degrees as they pass through different portions of a patient 36. For example, bone will typically attenuate a greater percentage of photons than tissue. Similarly, air filled space in a lung or sinus cavity will attenuate less photons than a comparable space filled with tissue or bone. Thus, if an organ emitting photons is located on one side of a patient's body 36, photon density on the organ side of the body will typically be greater than density on the other side. Non-uniform attenuation about the organ causes emission image errors. For example, non-uniform attenuation causes artifacts in the planar images 52 and 54 which can obscure the planar images 52 and 54 and reduce diagnostic effectiveness.

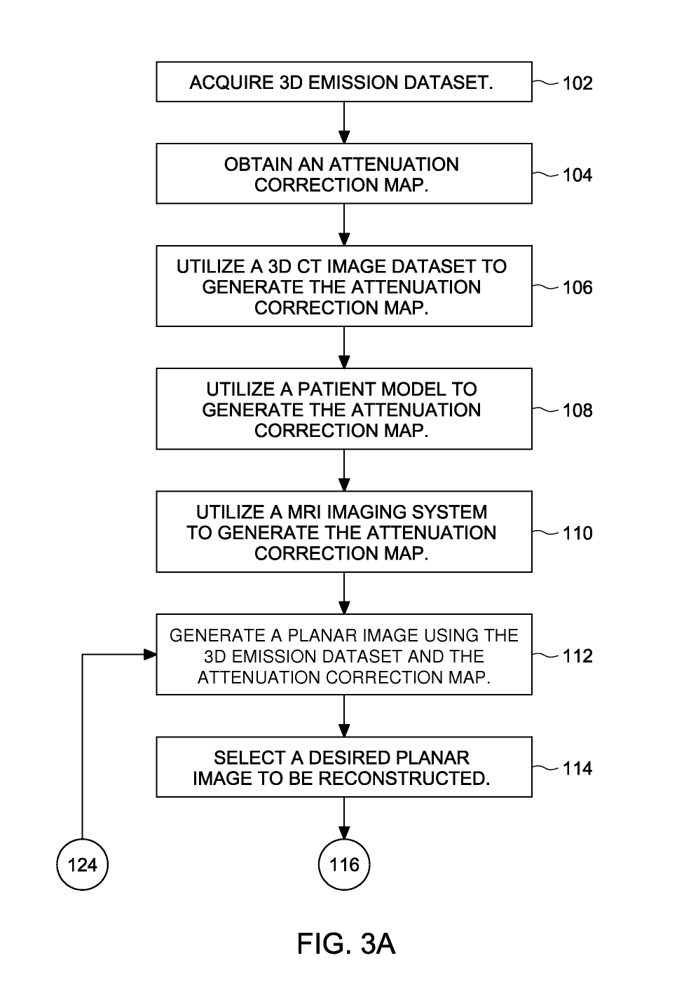

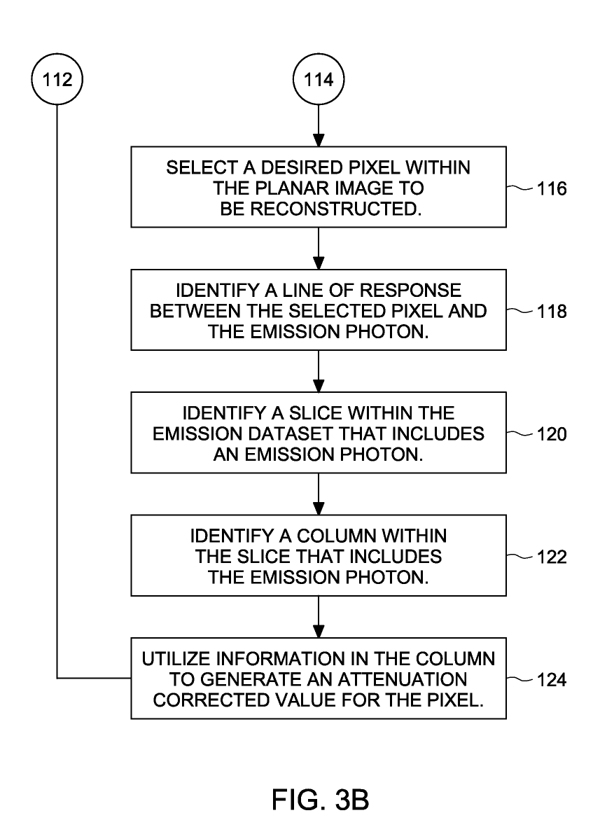

FIG. 3 is a flowchart of an exemplary method 100 of generating a planar image from a three-dimensional emission dataset. The method 100 may be performed by the image reconstruction processor 50 shown in FIG. 2. Optionally, the reconstructed, or raw data may be transferred to a “processing/viewing station” located locally or remote from the imaging system, (e.g. at a physician's home, or any location that is remote to the hospital) for data processing.

In the exemplary embodiment, the image reconstruction processor 50 is configured to acquire a three-dimensional (3D) emission dataset from the system 10. The image reconstruction processor 50 is also configured to acquire an attenuation map. The image reconstruction processor 50 is further configured to generate at least one synthetic two-dimensional (2D) or planar image using both the 3D emission dataset and the attenuation map. The method 100 may be applied to any 3D emission dataset obtained using any medical imaging modality. The method 100 may reduce noise related image artifacts in the planar images 52 and 54 by accounting for the non-uniform attenuation about the organ.

Referring to FIG. 3, at 102 a 3D emission dataset is acquired. In the exemplary embodiment, the 3D emission dataset is acquired from the SPECT system 10 shown in FIG. 1. Optionally, the 3D emission dataset may be acquired from, for example, a Positron Emission Tomography (PET) imaging system.

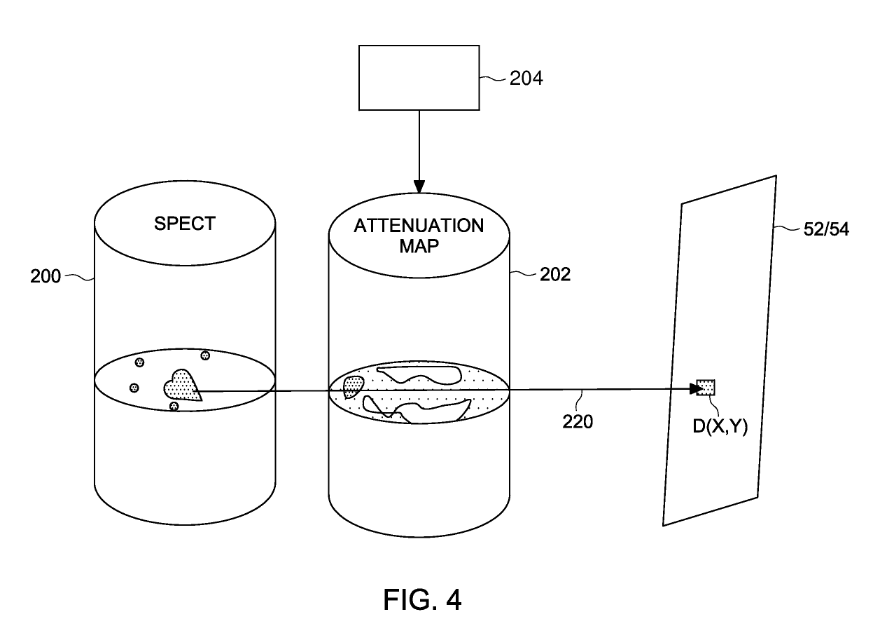

At 104 an attenuation correction map is obtained. In the exemplary embodiment, the system 10 utilizes a weighting algorithm that is configured to utilize selected data to attenuation correct the planar images 52 an/or 54. In one embodiment, the attenuation correction map utilizes a 3D computed tomography (CT) transmission dataset, and combines the selected CT transmission dataset into a set of attenuation correction factors, also referred to as the attenuation correction map, to attenuation correct the SPECT planar images 52 an/or 54. FIG. 4 illustrates an exemplary 3D emission dataset 200 acquired from the SPECT system 10 shown in FIG. 1. FIG. 4 also illustrates an exemplary attenuation correction map 202 that is used to attenuation correct the SPECT planar images 52 an/or 54.

Referring again to FIG. 3, in one embodiment, at 106, a 3D CT image dataset may be utilized to generate the attenuation correction map. For example, the patient 36 may initially be scanned with a CT imaging system to generate a 3D transmission dataset 204 shown in FIG. 4. The 3D transmission dataset 204 is then weighted to generate the attenuation correction map 202.

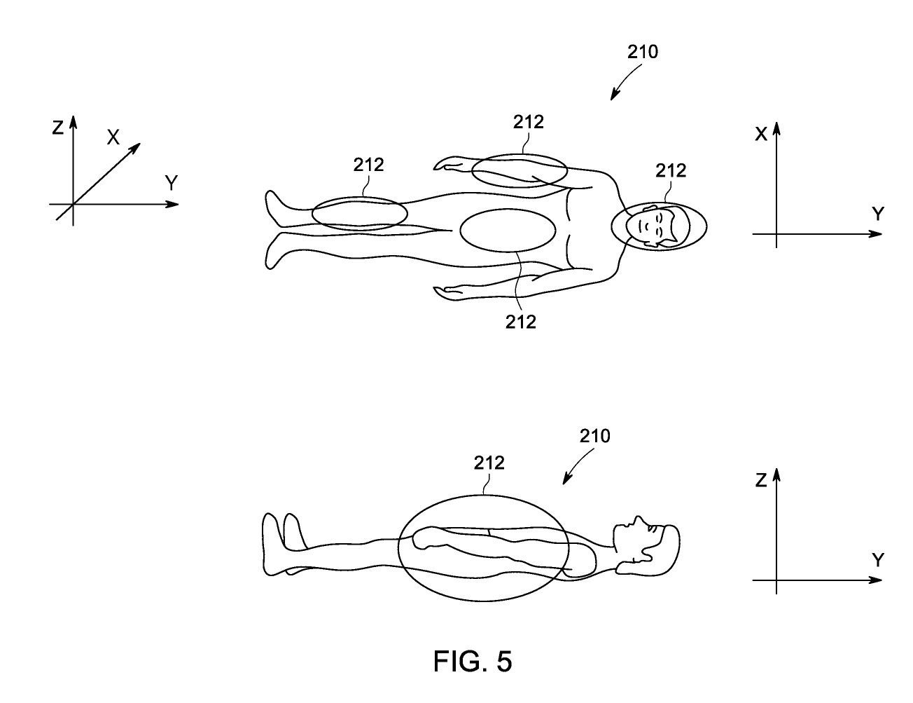

At 108 the attenuation correction map 202 may also be generated based on a model patient. For example, FIG. 5 illustrates a model 210 of an exemplary patient. As shown in FIG. 5, to generate the attenuation correction map 202, the model 210 is overlayed with a plurality of ellipses 212. The ellipses 212 indicate specific regions of the human body where the composition of the human body is generally known. For example, the chest area includes the lungs, heart, and ribs. Based on a priori information of the human body, the counts for each ellipse can be estimated. The counts are typically determined in accordance with:

$$CT ( naterial ) = \frac{1000 * \{ μ ( material ) - μ ( water ) \}}{μ ( water ) - μ ( air )}$$

wherein the values of μ(material), μ(water), and μ(air) are based on a priori knowledge of the human body at each selected ellipse 212.

Referring again to FIG. 3, at 110, the attenuation correction map 202 may also be generated using a 3D image dataset acquired from another imaging modality. For example, the attenuation correction map 202 may be generated based on information acquired from a PET imaging system or a Magnetic Resonance Imaging (MRI) imaging system. It should be noted that preferably the attenuation map obtained in 104 is scaled according to the energy of the photon emission used in 102. Optionally, when dual or multiple energy windows are used (such as multi-isotope imaging or when multi-peak isotope is used), a separate attenuation map is obtained (by different scaling) for each energy. Alternatively, a weighted average attenuation map is obtained for a multi-energy imaging.

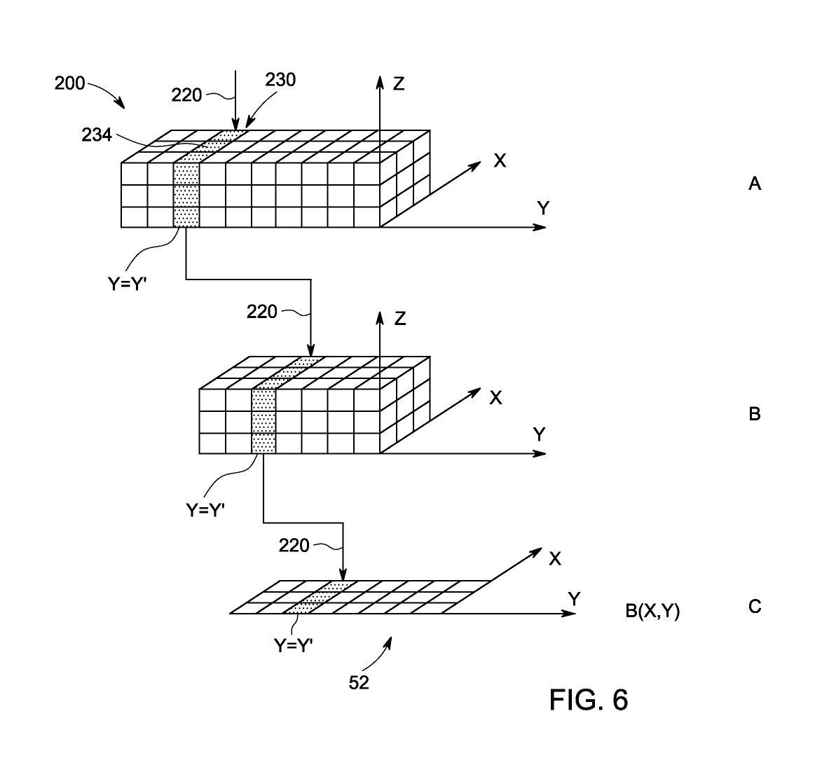

At 112, the system 10 is configured to generate a planar image using the 3D emission dataset 200 and the attenuation correction map 202. FIG. 6 is a 3D illustration of the exemplary 3D emission dataset 200 that may be used to reconstruct the planar image 52 and/or 54. The planar images 52 and/or 54 may be of any size. For example, the planar images 52 and 54 may be a 128×128 matrix of pixels, a 256×256 matrix of pixels, or any other size image.

Referring again to FIG. 3, at 114, the image reconstruction processor 50 selects a desired image to be reconstructed. For example, the planar image 52 of the patient 36 obtained from emission data received from the gamma camera 18 or the planar image 54 of the patient 36 is obtained from emission data received from the gamma camera 20. For ease of simplification, the method of 100 of generating a planar image from a three-dimensional emission dataset will be explained with reference to the planar image 54, e.g. the posterior image of the patient 36. In the exemplary embodiment, the “location of a synthetic (virtual) detector” is selected. The data set used is the entire #D image (acquired by the emission camera, with all its detectors). The selection is used to determine the direction of the “lines of integrals 220 (which are perpendicular to (and in the direction towards) the selected “virtual detector”). Since medical personnel are accustomed to “two heads cameras”; the selection is usually for: 1) two opposing (parallel) virtual detectors, or 2) two detectors at 90 degrees (less often).

At, 116, the image reconstruction processor 50 selects a desired pixel within the planar image to be reconstructed. For example, FIG. 6 illustrates the exemplary emission dataset 200 and also illustrates an exemplary pixel to be reconstructed. For ease of discussion, the exemplary pixel to be reconstructed to generate the planar image 54 is denoted as pixel B(x, y), where B denotes the bottom or planar image 54 and x, y denotes the Cartesian coordinates of the pixel B(x, y) in the planar image 54. As discussed above, the pixel B(x, y) is reconstructed using emission information acquired from the emission dataset 200 and attenuation information acquired from the attenuation map 202. Therefore, to reconstruct the pixel B(x, y), the image reconstruction processor 50 is configured to identify the coordinates within the emission data that include the photon 234 emitted from the patient 36 (shown in FIG. 6 illustration A) and also identify any attenuation data that contributes to the signal used by the image reconstruction processor 50 to reconstruct the pixel B(x, y) in the planar image 54. More specifically, the image reconstruction processor 50 is configured to identify the photon 234, (e.g., the emission source) in the 3D emission dataset 200 and also identify any attenuation voxels lying along the line of response between the emission photon and the pixel B(x, y). The voxels that contribute attenuation information to the pixel B(x, y) are denoted as 236. It should be realized that each of the voxels 236 between the photon 234 and the pixel B(x, y) contribute attenuation information that is accounted for when reconstructing the pixel B(x, y).

Therefore, at 118, the image reconstruction processor 50 identifies a line of response 220 between the selected pixel B(x, y) and the emission photon 234. The exemplary line of response 220 is shown in FIGS. 3 and 6.

At 120, the image reconstruction processor 50 identifies a slice within the emission dataset 200 that includes the emission photon 234. For example, referring to FIG. 6, illustrations A to C, the image reconstruction processor 50 may determine that the line of response 220 is represented by the voxels within a slice 232 denoted as slice Y≡Y′.

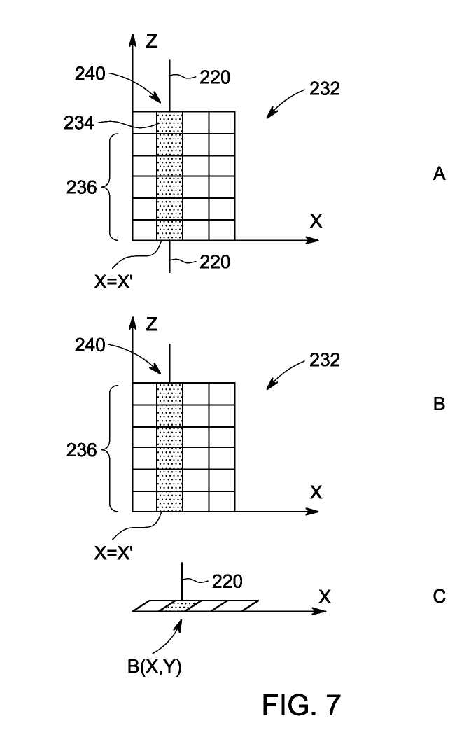

FIG. 7, illustration A is a 2D view of the slice Y≡Y′ shown in FIG. 6, illustration A to F. As shown in FIG. 7, illustration A, the slice includes the photon 234. Moreover, FIG. 7, illustration B and C depict a 2D view of the slice Y≡Y′ projected onto a portion of the planar image 54.

Referring again to FIG. 3, at 122, the reconstruction processor 50 identifies a column 240 within the slice 232 that includes the photon 234 and the attenuation voxels 236. In the exemplary embodiment, the column 240 includes all the information extending along the line of response 220. This information includes emission information for the photon 234 and voxel attenuation information 236 for any voxel that is disposed between the photon 234 and the pixel to be reconstructed, e.g. the pixel B(x, y). The information also includes attenuation information 238 that is along the line of response 220, but is not between the photon 234 and the pixel B(x, y). For example, the voxels 238 are attenuation information that is located between the photon 234 and a pixel that is used to reconstruct the planar image 54. In order to reconstruct the pixel B(x, y) the voxel having the emission information, e.g. voxel 234 and any voxels located between the voxel 234 are identified, e.g. voxels 236. It should be realized that the location of the voxel 234 is identified using the emission dataset 200 and the locations of any voxels, e.g. voxels 236, that contribute attenuation information to the reconstructed pixel B(x,y) are determined using the attenuation correction map 202. Moreover, it should be realized that the FIG. 6 and FIG. 7 illustrate an emission dataset that is overlayed or registered with the attenuation correction map to identify the slices and columns described above.

At 124, the image reconstruction processor 50 utilizes the information in the column 240 to generate an attenuation corrected value for the pixel B(x, y). More specifically, the reconstruction processor 50 is configured to integrate the voxels along the line or response 220 to generate the attenuation corrected value. More specifically, the image reconstruction processor 50 utilizes the information in the column 240 to determine what the signal emitted from the emission point 234 to the gamma camera would have been if not for the attenuation of the signal between the emission point 234 and the gamma camera.

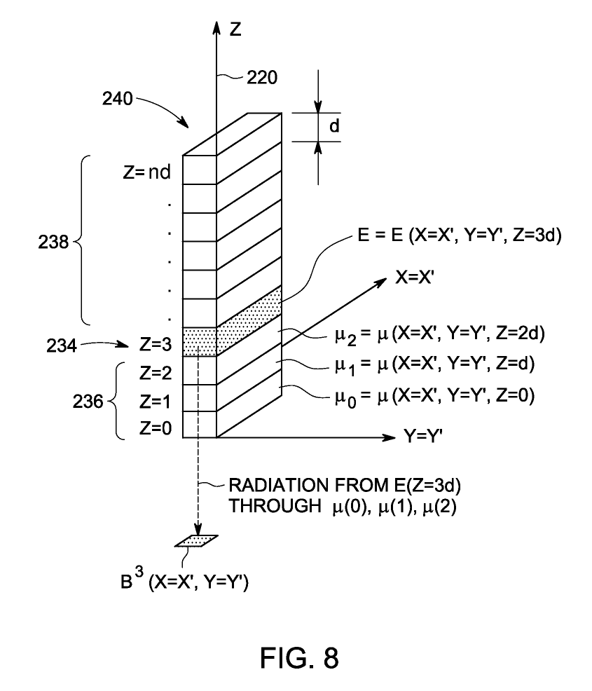

FIG. 8 is a 3D illustration of the exemplary column 240 including the photon 234 and the plurality of attenuation voxels 236. As shown in FIG. 8, the line of response 220 extends from the emission point 234 through the plurality of voxels 236 that contribute to attenuation. For ease of explanation, the voxels are labeled based on 3D Cartesian coordinates. For example, the voxel nearest the pixel B(x, y) to be reconstructed is labeled Z=0, the next voxel is labeled Z=d, wherein d is the width of the voxel in 3D space. The next voxel Z=2d and the voxel including the emission information, e.g. the emission point 234, is labeled Z=3d.

As shown in FIG. 8, the voxel Z=3d includes only emission data. Specifically, radiation emitted from the photon 234 which is represented mathematically as:

E=E(X≡X¹,Y≡Y¹,Z≡3·d)

where E is emission data in three dimensions, and d is the size of the voxel. For example, 0 to d is a single voxel; d to 2d is another voxel, 2d to 3d is another voxel; and 3d to 4d is the voxel containing the emission information.

The voxels 236 located between the emission point 234 and the pixel B(x,y) generally include only attenuation data. Therefore, the voxel Z=0 is represented as μ₀=μ(X=X¹, Y=Y¹, Z=0); the voxel Z=d is represented as μ_{d}=μ(X=X¹, Y=Y¹, Z=d); the voxel Z=2d is represented as μ_{2d}=μ(X=X¹, Y=Y¹, Z=2·d); and the voxel

For example, assuming the emission point 234 is located in the heart of the patient 236, the method first determines the contribution of emission data to the pixel B(x, y). As discussed above, the emission point 234 is located in the voxel 3d, therefore the Cartesian coordinates for the emission point are:

$$voxel 3 d \{ \begin{matrix}X = {X}^{1} \\ Y = {X}^{1} \\ Z = 3 \cdot d\end{matrix} \}$$

and the individual contributions for each voxel that contributes to the pixel B(x, y) as a result of the emission data is determined in accordance with:

$${B}^{( 3 )} ( {X}^{1} , {Y}^{1} ) = E ( {X}^{1} , {Y}^{1} , Z = 3 \cdot d ) \cdot {e}^{- d * {\sum }_{i = 0}^{2} μ ( {X}^{1} , {Y}^{1} , d \cdot i )}$$

Or generally:

$${B}^{( k )} ( {X}^{1} , {Y}^{1} ) = E ( {X}^{1} , {Y}^{1} , Z = k \cdot d ) \cdot {e}^{- d * {\sum }_{i = 0}^{k - 1} μ ( {X}^{1} , {Y}^{1} , d \cdot i )}$$

where μ is the attenuation for each voxel, d0, d1, d2, etc along the line of response 220.

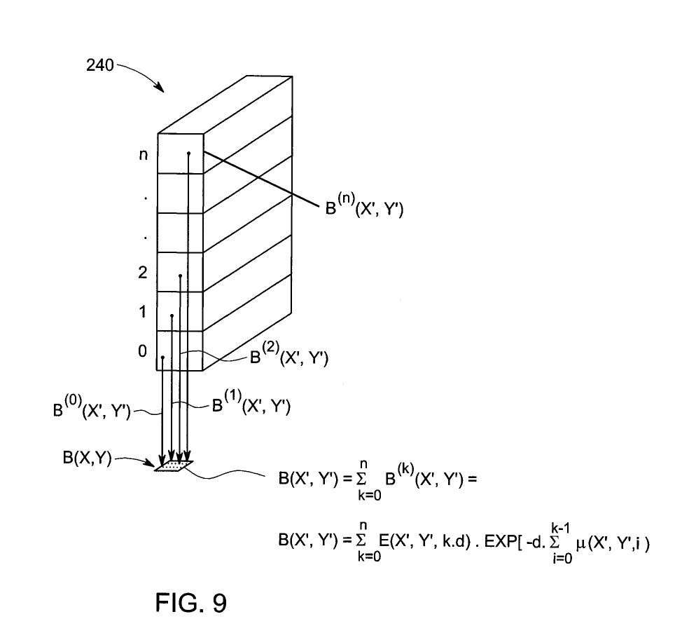

FIG. 9 is a 3D illustration of the exemplary column 240 including the total voxels 236 (labeled 0 . . . n) that contribute to the pixel B(x, y). In the exemplary embodiment the total contribution is first determined by summing the individual contributions from each voxel as discussed above. In the exemplary embodiment, the total contribution to pixel B(x, y), e.g. the attenuation corrected value, are determined in accordance with:

$$. B ( {X}^{′} , {Y}^{′} ) = {\sum }_{k = 0}^{n} {B}^{( k )} ( {X}^{′} , {Y}^{′} ) = {\sum }_{k = 0}^{n} {E ( {x}^{′} , {y}^{′} , k * d )}^{- d {\sum }_{i = 0}^{k - 1} μ ( {x}^{′} {y}^{′} , i )}$$

It should be noted that the order of performing the dual summation may vary. For example, summing order may be altered to save computation time, for example for decreasing the mathematical operation or to decrease memory access time. In some embodiments, array processor or vector processor or multi-core parallel processor may be used.

It should be realized that the method described at steps 116-124 are iterative. More specifically, after the pixel B(x, y) is corrected, another pixel is selected and the method described in steps 116-124 is repeated. The methods described herein are performed on each pixel in the planar image 54. It should also be realized that although the methods herein are described with respect to correcting the posterior image 54, the methods may also be applied to the anterior image 52.

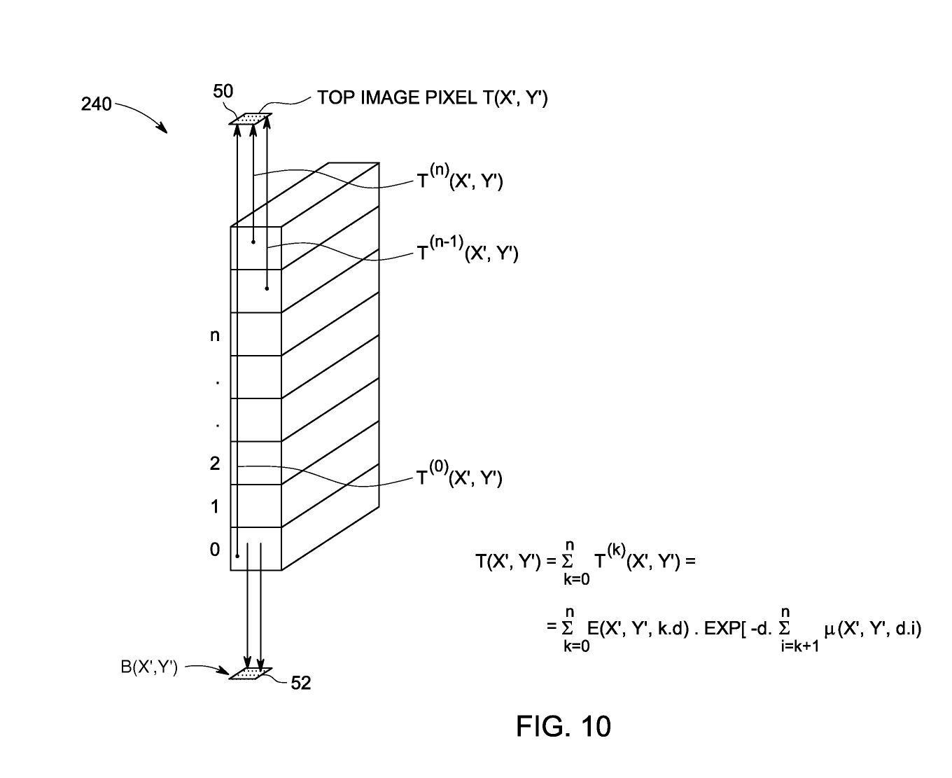

For example, FIG. 10 is a 3D illustration of the exemplary column 240, discussed above, including an exemplary pixel T(x, y) to be reconstructed in the planar image 52. The voxels that contribute to the pixel T(x, y) are labeled T₀ . . . Tₙ. The total contribution to the pixel T(x, y) is then determined in accordance with:

$$. T ( {X}^{1} , {Y}^{1} ) = {\sum }_{l = 0}^{n} {T}^{k} ( {x}^{′} {t}^{′} ) = {\sum }_{l = 0}^{n} {E ( {x}^{′} , {t}^{′} , k * d )}^{- d * {\sum }_{i = k + 1}^{n} μ ( {x}^{″} {y}^{″} , di}$$

It should be realized that the above equation is calculated for each pixel to generate the planar image 52. As a result, to generate a synthetic image, the voxel having the emission data is multiplied by the by exponential of the total attenuation. This value is then summed for each voxel 1 . . . n to acquire the signal that is used to reconstruct the selected pixel. Moreover, this method is applied to each pixel to form the synthetic planar images 52 and/or 54.

At least one technical effect of some of the embodiments is to provide medical personnel with a high quality planar image that enables the medical personnel to identify medical conditions. The methods described herein generate a 3D emission dataset that is utilized to generate a high-quality 2D synthetic image. The 2D synthetic images enable the medical personnel to ascertain a status of many medical conditions. After reviewing the 2D synthetic images, the medical personnel may determine that a more detailed examination is required. The medical personnel may then review the data in a 3D format without performing an additional scan. Thus, the methods described herein enable medical personnel to obtain and review both 2D planar images and 3D images while performing only a single scanning procedure. It should be noted that some gamma emission cameras are incapable to acquire 2D planar images such as acquired by single or dual flat detector single photon detectors equipped with parallel hole collimators. For example, gamma cameras equipped with fan beam collimator distorts the 2D image they acquire when stationary. Similarly, multi-pinhole cameras and PET cameras are incapable of acquiring planar 2D images. For these cameras, synthetic 2D planar images reconstructed according to a method according to the currant invention enable the user to view the patient as if it was imaged by a conventional gamma camera. Additionally, regardless of the patient orientation on the table, the 3D data set may be rotated and a 2D synthetic planar image reconstructed in any orientation desired by the viewer. Currently, medical personnel often acquires both 2D and 3D data sets to enable viewing both types of images. Although acquiring 2D image often requires less time than acquiring 3D dataset, the additional time for acquiring the 2D dataset is made unnecessary by using a method according the current invention, thus reduces acquisition time, reduces patient discomfort and increasing camera throughput.

It should be noted that the various embodiments of the invention may be implemented entirely in software on general purpose computers. In other embodiments, a combination of a software and hardware implementation may be provided.

Some embodiments of the present invention provide a machine-readable medium or media having instructions recorded thereon for a processor or computer to operate an imaging apparatus to perform one or more embodiments of the methods described herein. The medium or media may be any type of CD-ROM, DVD, floppy disk, hard disk, optical disk, flash RAM drive, or other type of computer-readable medium or a combination thereof. For example, the image reconstruction processor 50 may include a set of instructions to implement the methods describe herein.

The various embodiments and/or components, for example, the processors, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). While the dimensions and types of materials described herein are intended to define the parameters of the invention, they are by no means limiting and are exemplary embodiments. Many other embodiments will be apparent to those of skill in the art upon reviewing and understanding the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for synthesizing a planar image from a three-dimensional emission dataset, said method comprising:
acquiring a three-dimensional (3D) emission dataset of an object of interest;
obtaining a three-dimensional (3D) attenuation map of the object of interest;
determining a line of response that extends from an emission point in the 3D emission dataset, through the 3D attenuation map, to a pixel to be reconstructed on a planar image;
integrating along the line of response to generate an attenuation corrected value for the pixel; and
reconstructing the planar image using the attenuation correction value.

2. The method of claim 1 wherein obtaining a three-dimensional (3D) attenuation map further comprises synthesizing a three-dimensional (3D) attenuation map of the object of interest based on at least one emission profile.

3. The method of claim 1 further comprising rotating the 3D dataset prior to reconstructing the planar image.

4. The method of claim 1 further comprising:
determining a line of response that extends through each emission point in the 3D emission dataset; and
integrating along the line or response for each pixel to generate an attenuation corrected value for each pixel; and
reconstructing the planar image using the plurality of attenuation correction values.

5. The method of claim 1 wherein the integrating comprises:
determining a value for each attenuation contribution to the pixel along the line of response; and
summing the values for each pixel.

6. The method of claim 1 wherein acquiring the three-dimensional (3D) attenuation map further comprises generating the 3D attenuation map from a 3D Computed Tomography (CT) transmission dataset.

7. The method of claim 1 wherein acquiring the three-dimensional (3D) emission dataset further comprises acquiring at least one of a Single Photon Emission Computed Tomography (SPECT) dataset and a Positron Emission Tomography (PET) dataset.

8. The method of claim 1 wherein acquiring the three-dimensional (3D) attenuation map further comprises:
generating a model of a 3D computed tomography (CT) transmission dataset; and
generating the 3D attenuation map from the model.

9. The method of claim 1 wherein the acquiring a three-dimensional (3D) attenuation map further comprises generating the 3D attenuation map from an Magnetic Resonance Imaging (MRI) dataset.

10. The method of claim 1 further comprising integrating along the line of response in a direction that is opposite to the direction used to generate the planar image to generate a second planar image.

11. The method of claim 1 further comprising determining the value of the pixel in accordance with:
$$B ( {X}^{′} , {Y}^{′} ) = {\sum }_{k = 0}^{n} {B}^{( k )} ( {X}^{′} , {Y}^{′} ) {\sum }_{k = 0}^{n} {E ( {x}^{′} , {y}^{′} , k * d )}^{{ }^{- d {\sum }_{i = 0}^{k - 1} μ ( {x}^{′} {y}^{′} , i )}}$$
where: B(x, y) is a pixel being reconstructed:
k is the column number including the line of response; and
d is the pixel location along the line of response.

12. A medical imaging system comprising:
a first gamma camera;
a second gamma camera; and
an image reconstruction processor configured to receive emission data from the first and second gamma cameras, the image reconstruction processor configured to
acquire a three-dimensional (3D) emission dataset of an object of interest;
obtain a three-dimensional (3D) attenuation map of the object of interest;
determine a line of response that extends from an emission point in the 3D emission dataset, through the 3D attenuation map, to a pixel to be reconstructed on a planar image;
integrate along the line of response to generate an attenuation corrected value for the pixel; and
reconstruct the planar image using the attenuation correction value.

13. A medical imaging system in accordance with claim 12 wherein the first and second gamma cameras form a first imaging modality, the medical imaging system further comprising a different second imaging modality.

14. A medical imaging system in accordance with claim 12 wherein the first and second gamma cameras form a first imaging modality, the medical imaging system further comprising a Computed Tomography (CT) imaging system.

15. A medical imaging system in accordance with claim 12 wherein the image reconstruction processor is further configured to:
determine a line of response that extends through each emission point in the 3D emission dataset;
integrate along the line or response for each pixel to generate an attenuation corrected value for each pixel; and
reconstruct the planar image using the plurality of attenuation correction values.

16. A medical imaging system in accordance with claim 12 wherein the image reconstruction processor is further configured to:
determine a value for each attenuation contribution to the pixel along the line of response; and
sum the values for each pixel.

17. A medical imaging system in accordance with claim 12 wherein the image reconstruction processor is further configured to:
acquire at least one of a Single Photon Emission Computed Tomography (SPECT) dataset and a Positron Emission Tomography (PET) dataset.

18. A medical imaging system in accordance with claim 12 wherein the image reconstruction processor is further configured to:
generate a model of a 3D computed tomography (CT) transmission dataset; and
generate the 3D attenuation map from the model.

19. A medical imaging system in accordance with claim 12 wherein the image reconstruction processor is further configured to integrate along the line of response in a direction that is opposite to the direction used to generate the planar image to generate a second planar image.

20. A computer readable medium encoded with a program to instruct a computer to:
acquire a three-dimensional (3D) emission dataset of an object of interest;
obtain a three-dimensional (3D) attenuation map of the object of interest;
determine a line of response that extends from an emission point in the 3D emission dataset, through the 3D attenuation map, to a pixel to be reconstructed on a planar image;
integrate along the line of response to generate an attenuation corrected value for the pixel; and
reconstruct the planar image using the attenuation correction value.

21. A computer readable medium in accordance with claim 20 wherein the program is programmed to further instruct a computer to:
determine a line of response that extends through each emission point in the 3D emission dataset; and
integrate along the line or response for each pixel to generate an attenuation corrected value for each pixel; and
reconstruct the planar image using the plurality of attenuation correction values.

22. A computer readable medium in accordance with claim 20 wherein the program is programmed to further instruct a computer to integrate along the line of response in a direction that is opposite to the direction used to generate the planar image to generate a second planar image.
